(19) United States
(12) Patent Application Publication
(10) Pub. No.: US 2010/0020324 A1
(43) Pub. Date: Jan. 28, 2010

(54) MICRO-DISTANCE MEASURING METHOD AND DEVICE

(75) Inventor: Akiyoshi UCHIDA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/503,344

(22) Filed: Jul. 15, 2009

(30) Foreign Application Priority Data
Jul. 24, 2008 (JP) 2008-190490

(51) Int. Cl. G01J 4/00

(52) U.S. Cl. 356/369

(57) ABSTRACT

A micro-distance measuring method includes: collecting measurement light projected from a light projection part by lens, inversely correcting astigmatism of the measurement light by a correction optical part, making the measurement light incident on a translucent substrate at an oblique angle so that the astigmatism of the measurement light inversely corrected by the correction optical part is canceled, projecting the measurement light, passing through the translucent substrate, on an object adjacent to the translucent substrate, and receiving light reflected on the object, detecting a phase difference between polarized components of the received light, which are different in the vibration direction, and determining a distance between the substrate and the object on the basis of the detected phased difference.

### CROSS-REFERENCE TO RELATED APPLICATIONS

This application is based upon and claims the benefit of priority of the prior Japanese Patent Application No. 2008-190490, filed on Jul. 24, 2008, the entire contents of which are incorporated herein by reference.

### FIELD

Embodiments of the present invention relates to a micro-distance measuring method and a micro-distance measuring device for measuring a micro distance.

### BACKGROUND

A hard disk drive as data storage is incorporated in various devices such as a computer. A method for precisely measuring a distance between objects slightly separated from each other is important for the performance evaluation of the hard disk drive. A hard disk drive typically includes a slider, which supports a magnetic head and positions the magnetic head very close to a hard disk rotating at high speed. A distance between the slider and the hard disk is called a fly-height, a floating height, or a head gap. The fly-height of a slider used in a hard disk drive is closely related to a recording density of the hard disk. Hence, a method for precisely measuring a distance (such as a fly height) between objects slightly separated from each other (such as between the slider and the hard disk) is useful for the performance evaluation of the hard disk drive

Because a hard disk has an opaque magnetic recording layer, the fly-height cannot be optically measured. In the optical measurement of the fly-height, a glass disk as a translucent member is used instead of an opaque disk. The glass disk is rotated, and light for measurement is projected on a slider, provided adjacent to the glass disk, through the glass disk.

Japanese Patent Laid-Open Publication No. 8-271230 discloses a method of making the measurement light incident on a transparent disk not vertically but obliquely. In the measuring method, a reflected light having passed through a glass disk is reflected on the surface of a slider, called an ABS (Air Bearing surface), to be passed through the glass disk again, and then received by an intensity meter and a phase detector. Based on a relative phase between s-polarized light and p-polarized light of the received light and a light quantity of each of the polarized lights, the fly-height is calculated by using a known function. The measuring method has an advantageous that a complex refractive index of the slider surface is also measured by using an optical device serving to project and receive the measurement light. The complex refractive index is a parameter associated with the function and is measured for calculation of an accurate fly-height. In the measurement of the complex refractive index, the measurement light is projected on the slider not through a disk.

### SUMMARY

At least one embodiment of the present invention provides a micro-distance measuring method that includes: collecting measurement light projected from a light projection part by lens, inversely correcting astigmatism of the measurement light by correction optical part, making the measurement light incident on a translucent substrate at an oblique angle so that the astigmatism of the measurement light inversely corrected by the correction optical part is canceled, projecting the measurement light, passing through the translucent substrate, on an object adjacent to the translucent substrate, and receiving light reflected on the object, detecting a phase difference between polarized components of the received light, which are different in the vibration direction, and determining a distance between the substrate and the object on the basis of the detected phased difference.

It is to be understood that both the foregoing general description and the following detailed description are exemplary and explanatory and are not restrictive of the present invention as claimed.

### BRIEF DESCRIPTION OF THE DRAWINGS

Embodiments are illustrated by way of examples and not limited by the following figures:

FIG. 1 is a view of a fly-height measuring device according to an example of an embodiment of the present invention;

FIG. 2 is a graph illustrating a relationship between a phase difference between p-polarized light and s-polarized light and a fly-height according to an example of an embodiment of the present invention;

FIG. 3 is a view illustrating the fly-height measuring device when operated as an ellipsometer according to an example of an embodiment of the present invention;

FIGS. 4A to 4C are views illustrating the direction of disposition of a corrector plate according to an example of an embodiment of the present invention;

FIGS. 5A and 5B are views illustrating variations of the disposition of corrector plates according to an example of an embodiment of the present invention; and

FIG. 6 is a view of another fly-height measuring device according to an example of an embodiment of the present invention.

### DETAILED DESCRIPTION OF EXAMPLES OF EMBODIMENTS

In the figures, dimensions and/or proportions may be exaggerated for clarity of illustration. For example, when the performance of a slider with a complex surface shape is evaluated, the fly-height is measured, focusing on a portion of the surface of the slider, or each fly-height of a plurality of portions of the slider surface is measured.

In one example of an embodiment of the present invention, there is provided an effective measurement of a distance between a minute object and an adjacent translucent object or a distance between a minute region of a surface of an object and the adjacent translucent object.

Also, in an example of an embodiment for a micro-distance measuring method, a distance between a translucent substrate and a adjacent object is optically measured. The micro-distance measuring method includes collecting light by a lens to pass through the substrate to be projected on the object. At this time, the light is made incident on a surface of the substrate at an oblique angle. The method also includes receiving light that has been reflected on a surface of the object to pass through the substrate, detecting the phase difference between the polarization components of the received light, which are different in the vibration direction, determining a distance between the substrate and the object based on the detected phase difference. A translucent member reduces the spread of an irradiation spot on the object due to astigmatism of the light having passed through the substrate. In the aforementioned micro-distance measuring method, the translucent member is inserted into a light path between the lens and the substrate. Further, in the micro-distance measuring method, light having passed through the translucent member and the substrate is made incident on the object.

The insertion of the translucent member reduces the spread of the irradiation spot on the object. A distance between a smaller region of the object surface and the adjacent substrate may be measured. Further, the irradiation intensity near the center of the spot is increased. An SN ratio of a light receiving signal is increased to enhance the measurement accuracy.

In a preferable aspect, a corrector plate, which is used as the translucent member and is substantially equivalent in material and thickness to the substrate, is inserted into the light path. In this case, the incident angle of light incident on the corrector plate is substantially equal to an oblique angle, and in addition, the corrector plate is disposed to follow the p-polarization direction of light incident on the substrate. According to this aspect, the irradiation spot on the object is relatively easily narrowed down with the use of a plate which is substantially the same kind as the substrate, without using a special optical member.

Further, an even number of corrector plates, which are used as the translucent members and are substantially equivalent in material and thickness to the substrate, are inserted into the light path. In this case, in advance, the total thickness of a first corrector plate, which is half of the corrector plate, and the total thickness of a second corrector plate, which is the remaining half of the corrector plate, are respectively the half thickness of the substrate. The incident angle of light incident on the first corrector plate is substantially equal to an oblique angle. In addition, the first corrector plate is disposed to follow the p-polarization direction of the light incident on the substrate. The incident angle of light incident on the second corrector plate is substantially equal to the oblique angle. In addition, the second corrector plate is disposed to follow the p-polarization direction and to be prevented from being parallel to the first corrector plate. In this aspect, the displacement of the optical axis attributable to the first correction plate and the displacement of the optical axis attributable to the second correction plate are offset to each other. The deviation of the position of the irradiation spot on the object due to the insertion of these corrector plates is reduced.

The material of the translucent member is not necessarily required to be exactly the same as the material of the substrate. The optical properties (mainly, the complex refractive index) of the translucent member may be similar to the optical properties of the substrate so that a satisfactorily small desired irradiation spot diameter may be obtained.

A cylindrical lens may be used as the translucent member. The radius of curvature of the cylindrical lens is selected in response to the numerical aperture (NA) of a lens for projection. The cylindrical lens is appropriately disposed so that astigmatism occurring due to the incidence of light on the substrate at an oblique angle is reduced.

In another example of an embodiment of a micro-distance measuring device, a distance between a translucent substrate and the adjacent object is optically measured. The micro-distance measuring device includes light projector, light receptor, and signal processor. The light projector has a translucent member, and further has a laser light source and a lens. In the light projector, laser beam collected by the lens is passed through the substrate to be projected on an object. At that time, the light projector makes the laser beam incident on a surface of the substrate at an oblique angle. The light receptor receives the laser beam that has been reflected on the surface of the object to pass through the substrate. The light receptor detects the phase difference between the polarized components of the received laser beam, which are different in the vibration direction. The signal processor determines a distance between the substrate and the object based on the detected phase difference. The translucent member is inserted into a light path between the lens and the substrate. Further, the translucent member reduces the spread of the irradiation spot on the object due to the astigmatism of the light having passed through the substrate.

Further, the distance between a minute object and the adjacent translucent object or the distance between a minute region of a surface of an object and the adjacent translucent object is measured.

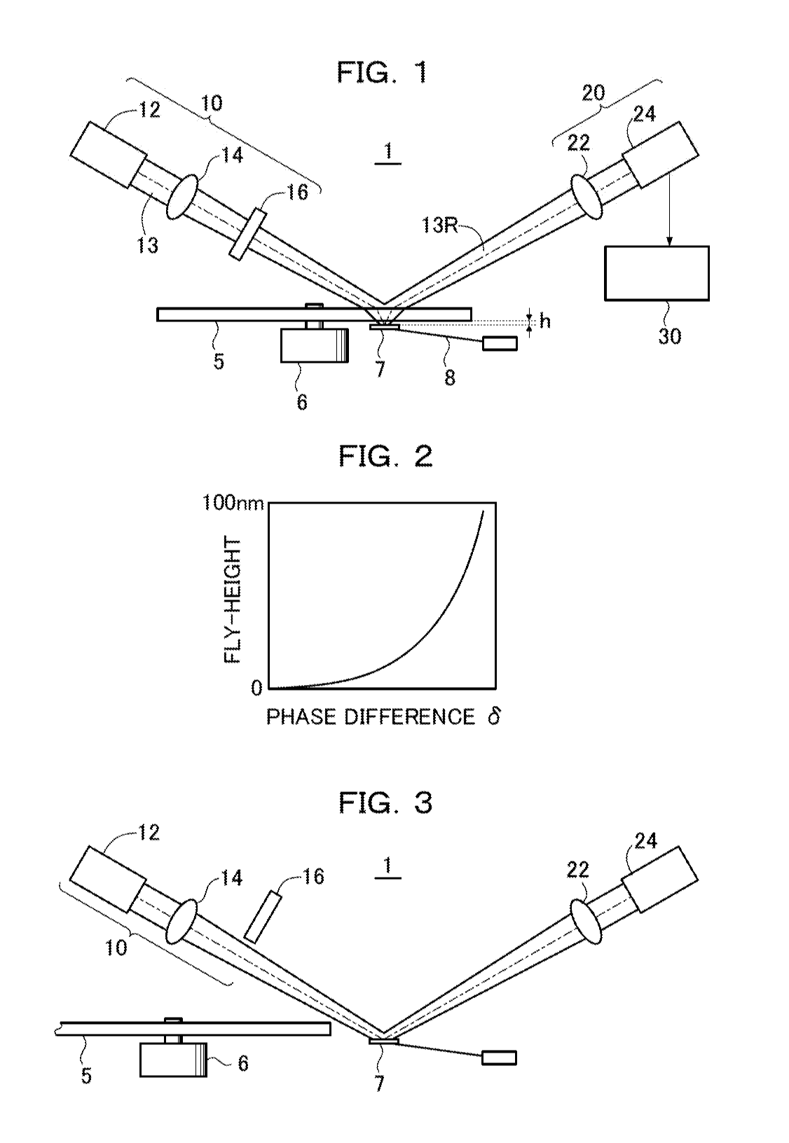

FIG. 1 is a schematic diagram of a fly-height measuring device 1. The fly-height measuring device 1 is a micro-distance measuring device for optically measuring a distance h (hereinafter referred to as a fly-height h) between a glass disk 5 which is a translucent substrate and a slider 7 which is an object adjacent to the glass disk 5. The fly-height measuring device 1 may be used in performance test of one or a plurality of prototypes in design evaluation of a slider which is a component of a hard disk drive, and is also used in production inspection in mass production of the slider.

As illustrated in FIG. 1, the fly-height measuring device 1 has the glass disk 5, a spindle motor 6, the slider 7, a head gimbal assembly 8, light projector 10, light receptor 20, and signal processor. The glass disk 5 is used as a substitute for a hard disk (recording medium). The spindle motor 6 rotates the glass disk 5 at high speed. The head gimbal assembly 8 supports the slider 7 in a cantilever manner. The light projector 10 emits a laser beam 13 toward the slider 7. The light receptor 20 receives a laser beam 13R reflected on a surface (ABS) of the slider 7. The signal processor calculates the fly-height h based on an output of the light receptor 20. A computer 30 is operated as the signal processor. The fly-height measuring device 1 further has a sliding table mechanism and a monitor device (not illustrated). The sliding table mechanism changes the relative position in a direction along a disk surface between the glass disk 5 and the slider 7. The monitor device displays on a screen an image of the slider 7 taken at a resolution allowing discrimination of the irradiation spot position.

The light projector 10 is provided with a HeNe laser light source 12, a lens 14 for collection, and a corrector plate 16. The HeNe laser light source 12 emits the laser beam 13 with a wavelength of 632.8 nm. The collection lens 14 is incorporated in a focus adjustment mechanism (not illustrated) and has a numerical aperture NA of 0.01 or less. The light projector 10 is designed to be suitable for the measurement of the fly-height h of 10 nm or less. The light receptor 20 is provided with an objective lens 22 and a detector 24. The detector 24 detects the phase difference between a p-polarized component and an s-polarized component. The p-polarized component and the s-polarized component are polarized components in directions perpendicular to each other.

In FIG. 1, the slider 7 is disposed below the glass disk 5; however, the disk 5 may be disposed below the slider 7. In each case, the laser beam is projected on the ABS, which is the surface of the slider 7 and is opposed to the glass disk 5, through the glass disk 5.

The fly-height h is measured in such a state that the glass disk 5 rotates at high speed. The laser beam 13 is collected by the lens 14 of the light projector 10. The laser beam 13 passes through the glass disk 5 to be applied to the slider 7. At this time, the light projector 10 makes the laser beam 13 incident on a surface of the glass disk 5 at an oblique angle θ. The oblique angle θ is, for example, about 60°. The laser beam 13 is obliquely incident on the surface, whereby specular reflection on the glass disk 5 occurring at vertical incidence does not occur. In this aspect, the polarized component in the oblique angle direction is the p-polarized component. Meanwhile, the polarized component in a direction parallel to the glass disk 5 is the s-polarized component.

The laser beam 13 incident on the slider 7 is reflected on the surface of the slider 7. A portion of the reflected laser beam 13 passes through the glass disk 5 without being reflected on the surface of the glass disk 5 and travels toward the light receptor 20. Another portion of the reflected laser beam 13 is multiply reflected between the opposed surfaces of the glass disk 5 and the slider 7 to thereafter travel toward the light receptor 20. Namely, the light traveling toward the light receptor 20 includes the lights with different number of reflections. When the distance between the opposed surfaces of the glass disk 5 and the slider 7 (that is, the fly-height h) is about 100 nm or less, interference occurs due to the multiple reflection. The phase difference between the p-polarized component and the s-polarized component is generated. There is a theoretically fixed relationship between the phase difference and the fly-height h as illustrated in FIG. 2. The computer 30 determines the fly-height h by applying the detection result of the phase difference, obtained by the light receptor 20, to this relationship.

The relationship illustrated in FIG. 2 depends on three elements forming a layer structure in which the multiple reflection occurs. Namely, the relationship illustrated in FIG. 2 depends on each complex refractive index of the glass disk 5, the slider 7, and air filled in a gap between the glass disk 5 and the slider 7. Hereinafter, a value of the complex refractive index is referred to as (n, k). n is a refractive index of a real part. k is an extinction coefficient of an imaginary part. Regarding the three elements, (n, k) of the air is known and (1.0003, 0). (n, k) of the glass disk 5 is known before assembled on the fly-height measuring device 1. For example, when GD-FHT from OHARA is used as the glass disk 5, (n, k) of the glass disk 5 is (1.526, 0). However, for use in the performance evaluation of the slider 7, (n, k) of the slider 7 is often unknown. In order to more precisely measure the fly-height h, (n, k) of the irradiation spot of the slider 7 is previously measured. Therefore, the fly-height measuring device 1 is operated as an ellipsometer for measuring (n, k) of the slider 7.

FIG. 3 illustrates a state of the fly-height measuring device 1 operated as the ellipsometer. The sliding table mechanism is driven to move the glass disk 5 to a separating position deviated from a laser beam path. At this time, the glass disk 5 is moved to the separating position with, for example, the spindle motor 6. When the spindle motor 6 is fixed to a housing, the slider 7 and an optical system are moved. Further, the corrector plate 16 of the light projector 10 is moved to the separating position deviated from the laser beam path. Thereafter, the light projector 10 projects the laser beam directly on the slider 7 not through the glass disk 5. At this time, the incident angle with respect to the slider 7 is an oblique angle. The oblique angle the incident angle of the projection light with respect to the glass disk 5 in the measurement of the fly-height h, and is, for example, 60°. The oblique angle may be substantially the same as in the measurement. In the fly-height measuring device 1 of the present aspect, the laser light beam is converged by the lens 14 so that the irradiation spot on the slider 7 has an elliptical shape with a minor axis of about 20 μm and a major axis of 40 μm.

(n, k) of the slider 7 is preferably measured before the measurement of the fly-height h, or may be measured after the measurement of the fly-height h. The computer 30 previously stores each (n, k) of the glass disk 5 and the air. The computer 30 calculates the relationships between the phase difference and the fly-height h based on the stored (n, k). The computer 30 determines the measurement value of the fly-height h based on the calculated relationship and the measured phase difference. When the fly-height h is measured in order to evaluate the performance of a large number of sliders, (n, k) of these sliders are measured before measuring the fly-height h. In the measurement of the large number of sliders, these sliders are assembled on the fly-height measuring device 1 in order one by one, and (n, k) of the newly assembled slider is measured at every replacements of the slider. In order to measure a large number of sliders, (n, k) of these sliders are measured before measuring the fly-height h of the sliders.

The field of hard disk drive has improved a data transfer speed. In order to improve the data transfer speed, there is a tendency that a current applied to a magnetic head is rendered feeble. The magnetic head is brought close to a disk as a recording medium, whereby the current becomes feeble. When the magnetic head is brought close to the recording medium, the fly-height h of the slider which is the support of the magnetic head is preferably not more than 10 nm. As the fly-height h is smaller, an allowable error in the measurement is smaller. Namely, the fly-height h is required to be measured with a higher accuracy. Further, the slider is required to have a high performance, and therefore, the measurement of the fly-height h for the purpose of the performance evaluation, especially at the design stage, is applied to a plurality of portions of a surface of the slider, whereby the flying posture of the slider may be obtained. In general, the surface of the slider is not flat, but has irregularities so that good aerodynamic characteristics may be obtained. The protrusions and recesses of the surface of the slider are discriminated by the measurement of the fly-height h.

When the fly-height h is measured with respect to the plurality of portions of the surface of the slider, the irradiation spot on the slider surface in the light projection is satisfactorily rendered small so that light is incident on each position in a limited way. (n, k) is measured for each of the plurality of portions, and the position and the size of the irradiation spot in the measurement of (n, k) are rendered substantially the same as in the measurement of the fly-height h. In the actual measurement procedure, the position of the irradiation spot is changed in order while being monitored, and each (n, k) of the plurality of positions is measured. Thereafter, the irradiation spot position is changed in order likewise, and each fly-height h of the plurality of positions is measured.

However, in the measurement of (n, k), the laser beam is projected on the slider 7 not through the glass disk 5. Meanwhile, in the measurement of the fly-height h, the laser beam is projected on the slider 7 through the glass disk 5. If the laser beam is projected in the measurement of the fly-height h under substantially the same optical conditions as in the measurement of (n, k), the irradiation spot spreads. The p-polarized component and the s-polarized component of the light passing through the glass disk 5 have different refraction conditions. The s-polarized component is parallel to the disk 5. Therefore, the s-polarized component has substantially the same refraction condition as in a case where the laser beam 13 is incident on the glass disk 5 at a right angle. The p-polarized component is the polarized component in the direction in which the laser beam 13 is incident on the glass disk 5 at an oblique angle. Therefore, the p-polarized component has substantially the same refraction condition as in a case where the laser beam 13 is incident on the glass disk 5 at an oblique angle. Such a difference in the refraction conditions causes the astigmatism. Due to the astigmatism, the irradiation spot more spreads than the irradiation spot in the measurement of (n, k). The influence of the astigmatism is severe for the measurement of the fly-height h of not more than 10 nm. In order to reduce the spread of the irradiation spot due to the astigmatism, the plate-shaped corrector plate 16 provided in the light projector 10 is used.

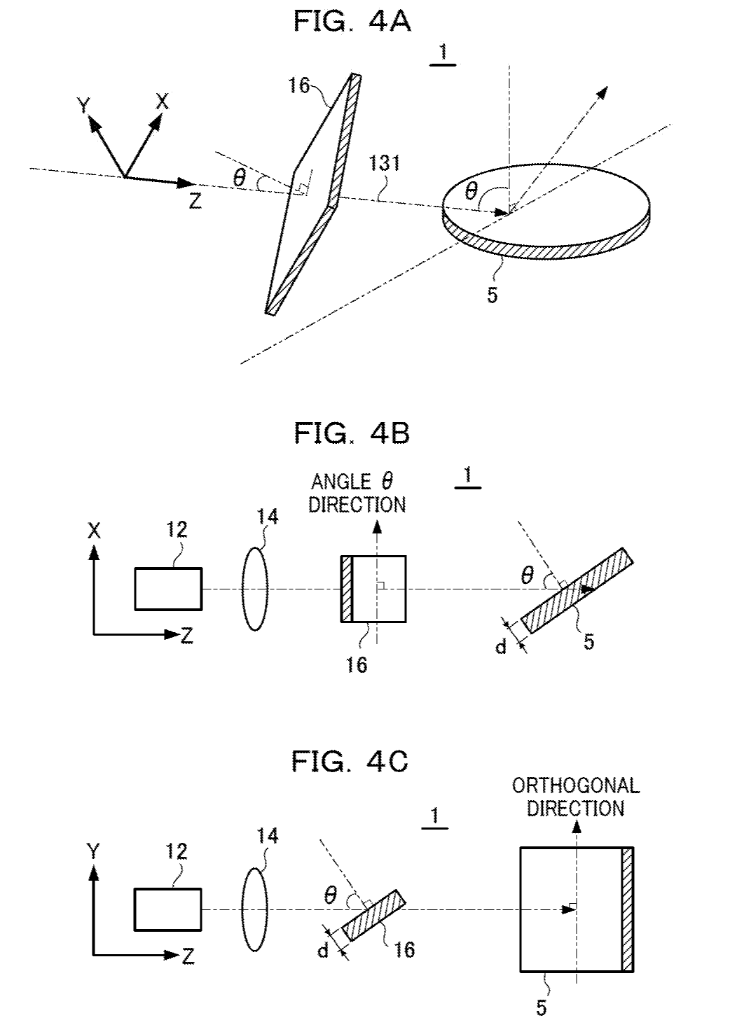

FIGS. 4A to 4C illustrate the direction of the displacement of the corrector plate 16. As illustrated in the perspective view of FIG. 4A, an orthogonal coordinate axis is determined with respect to an optical axis 131 of light incident on the glass disk 5 at an incident angle θ. A Z-axis is fixed in the travel direction of light. An X-axis is fixed in a direction along a virtual plane including the optical axis 131 and an optical axis of light reflected on the surface of the glass disk 5. Accordingly, a Y-axis perpendicular to the X-axis and the Z-axis is fixed. A p-polarized light vibrates in a direction along the X-axis of FIGS. 4A and 4B. In other words, the p-polarized light is the polarized component in the direction in which the laser beam 13 is incident on the glass disk 5 at an oblique angle. This direction is illustrated by the angle θ direction of FIG. 4B. An s-polarized light vibrates in a direction along the Y-axis of FIGS. 4A and 4C. In other words, the s-polarized light is the polarized component in the direction in which the laser beam 13 is perpendicularly incident on the glass disk 5. This direction is illustrated by the orthogonal direction of FIG. 4C.

FIG. 4B is a XZ plane view. FIG. 4C is a YZ plane view. The corrector plate 16 is inserted in a light path between the lens 14 and the glass disk 5. In this case, the incident angle of light incident on the corrector plate 16 is substantially equal to the oblique angle which is the incident angle θ on the glass disk 5. The corrector plate 16 is disposed so that the surface of the corrector plate 16 follows the p-polarization direction (that is, X axis). The thickness d of the corrector plate 16 is substantially the same as the thickness d of the glass disk 5. For example, when the glass disk 5 is GD-FHT from OHARA, the thickness d of the glass disk 5 and the corrector plate 16 is 4.45 mm. In FIG. 4A, the shaded area of the glass disk 5 is an end surface. In each of FIGS. 4B and 4C, the shaded area of the glass disk 5 is the cross-sectional surface. FIGS. 4B and 4C illustrate a portion of the glass disk 5 where the laser beam 13 is incident. In each of FIGS. 4A to 4C, the shaded area of the corrector plate 16 is the end surface.

The corrector plate 16 is formed of substantially the same material as the glass disk 5. As the corrector plate 16, a glass plate having the same composition as the glass disk 5, other glass disk having the same part number of the glass disk 5, or a glass plate cut out from these glass plates is used.

The corrector plat 16 is disposed between the lens 14 and the glass disk 5 in the above direction, whereby the refraction conditions of the p-polarized light and the s-polarized light between the lens 14 and the slider surface become uniform. Namely, the incident angle θ on the glass disk 5 is the angle on the plane along the p-polarized light, while the incident angle θ on the corrector plate 16 is the angle on the plane along the s-polarized light. Accordingly, the spread of the irradiation spot on the slider surface due to the astigmatism on the light path is reduced.

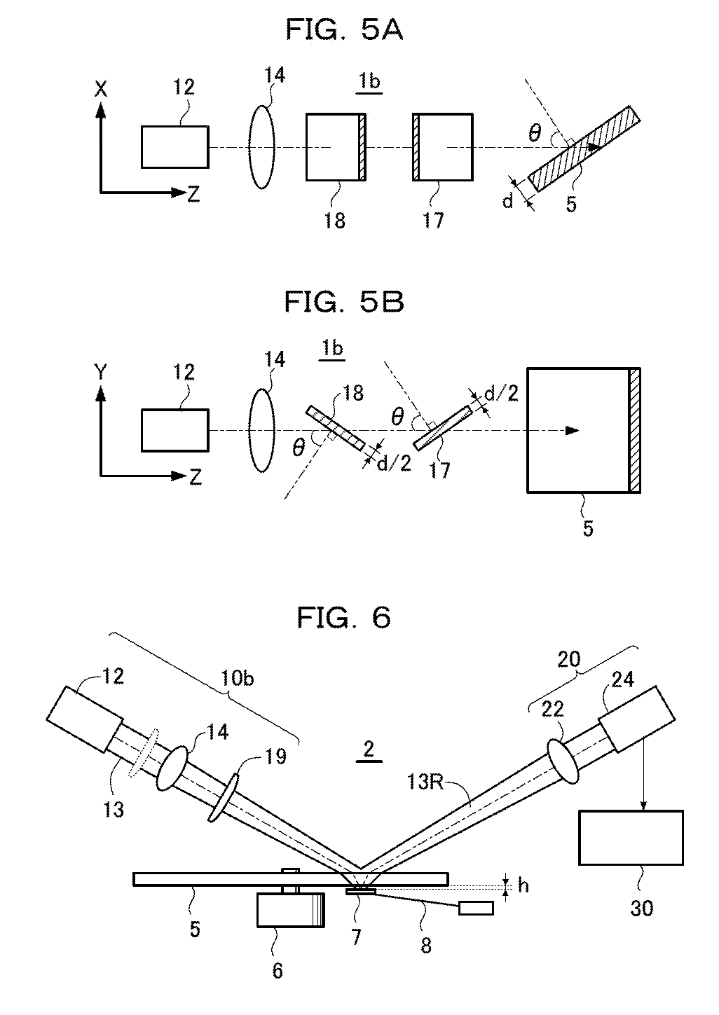

FIGS. 5A and 5B illustrate other aspects of the light projector 10. In the light projector 10, a total of an even number of first and second corrector plates 17 and 18 are inserted into a light path. In this example, two corrector plates are used. In a fly-height measuring device 1b, the direction of the disposition of the first corrector plate 17 with respect to the glass disk 5 is the same as the direction of the corrector plate 16 in the above example. Namely, the incident angle θ of light incident on the first corrector plate 17 is substantially equal to the oblique incident angle θ with respect to the glass disk 5. The first corrector plate 17 is disposed to follow the p-polarization direction of the light incident on the glass disk 5. Meanwhile, the incident angle θ of light incident on the second corrector plate 18 is substantially equal to the oblique incident angle θ with respect to the glass disk 5. The second corrector plate 18 is disposed to follow the p-polarization direction of the light incident on the glass disk 5. The second corrector plate 18 is disposed not in parallel to the first corrector plate 17. Each thickness of the first corrector plate 17 and the second corrector plate 18 is substantially half the thickness d of the glass disk 5 (d/2). Namely, the total thickness of the first and second corrector plates 17 and 18 is substantially equal to the thickness d of the glass disk 5. The first and second corrector plates 17 and 18 are formed of substantially the same material as the glass disk 5. In this example, although two corrector plates are used, four or more even number of corrector plates may be inserted. When four or more corrector plates are inserted, the total thickness of the half number of the corrector plates is half the thickness d of the glass disk 5, and the remaining half number of the corrector plates is also half the thickness d of the glass disk 5. As long as this condition is satisfied, the thickness of each corrector plate may be arbitrarily determined, and all corrector plates do not necessarily have the same thickness. The half number of the corrector plates are disposed in substantially the same direction as the first corrector plate 17, and the remaining half number of the corrector plates are disposed in the substantially same direction as the second corrector plate 18. In FIGS. 5A and 5B, the second corrector plate 18 is provided on the front side in the travel direction of the light, and the first corrector plate 17 is provided on the rear side in the travel direction of the light; however, the disposition order may be reversed.

When the even number of corrector plates 17 and 18 are inserted as illustrated in FIGS. 5A and 5B, the spread of the irradiation spot may be reduced as the above example. Further, the displacement of the optical axis attributable to the second corrector plate 18 and the displacement of the optical axis attributable to the first corrector plate 17 are offset to each other. The deviation of the position of the irradiation spot on the slider 7 due to the insertion of these corrector plates 17 and 18 is reduced. The deviation of the irradiation spot position is reduced, whereby when shifting from the measurement of (n, k) of the slider to the measurement of the fly-height h, the amount of adjustment of the irradiation spot position is reduced, or the irradiation spot position is not required to be adjusted.

Additionally, as in a fly-height measuring device 2 illustrated in FIG. 6, a cylindrical lens 19 may be inserted in a light path between a laser light source 12 and the glass disk 5. The cylindrical lens 19 may be inserted between the lens 14 and the glass disk 5. As another aspect, the cylindrical lens 19 may be inserted between the laser light source 12 and the lens 14 as drawn by a dashed line of FIG. 6. Further, the cylindrical lens 19 may be inserted between the lens 14 and the glass disk 5 and between the laser light source 12 and the lens 14. The cylindrical lens 19 is disposed in an appropriate direction, whereby the spread of the irradiation spot on the slider surface is reduced. Since the numerical aperture of the lens 14 is as small as not more than 0.01, the suitable radius of curvature of the cylindrical lens 19 is about several thousand mm. An actual surface of the cylindrical lens 19 is flatter than that illustrated in FIG. 6.

Examples of embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as set forth in the claims.

1. A micro-distance measuring method comprising:
collecting measurement light projected from a light projection part by a lens;
inversely correcting astigmatism of the measurement light by a correction optical part;
making the measurement light incident on a translucent substrate at an oblique angle so that the astigmatism of the measurement light inversely corrected by the correction optical part is canceled;
projecting the measurement light, passing through the translucent substrate, on an object adjacent to the translucent substrate;
receiving light reflected on the object;
detecting a phase difference between polarized components of the received light, which are different in the vibration direction; and
determining a distance between the substrate and the object on the basis of the detected phased difference.

2. The micro-distance measuring method according to claim 1, wherein the correction optical part is a corrector plate in which the material and the thickness are substantially equal to those of the translucent substrate, and in a polarization direction in which the measurement light is perpendicularly incident on the translucent substrate, the corrector plate is disposed so that the incident angle of the measurement light is substantially equal to the oblique angle, and in a polarization direction in which the measurement light is incident on the translucent substrate at an oblique angle, the corrector plate is disposed so as to be perpendicular to the measurement light.

3. The micro-distance measuring method according to claim 1, wherein the correction optical part includes an even number of corrector plates in which the material is substantially equal to that of the translucent substrate.

4. The micro-distance measure method according to claim 3, wherein the corrector plate has one or more first corrector plates and one or more second corrector plates, a total thickness of the first corrector plate and a total thickness of the second corrector plate being respectively equal substantially to half the thickness of the translucent substrate.

5. The micro-distance measure method according to claim 4, wherein in a polarization direction in which the measurement light is perpendicularly incident on the translucent substrate, the first corrector plate is disposed so that the incident angle of the measurement light is substantially equal to the oblique angle, and in a polarization direction in which the measurement light is incident on the translucent substrate at an oblique angle, the first corrector plate is disposed so as to be perpendicular to the measurement light.

6. The micro-distance measure method according to claim 5, wherein in the polarization direction in which the measurement light is perpendicularly incident on the translucent substrate, the second corrector plate is disposed so that the incident angle of the measurement light is substantially equal to the oblique angle, and in the polarization direction in which the measurement light is incident on the translucent substrate at an oblique angle, the second corrector plate is disposed so as to be perpendicular to the measurement light, and the second corrector plate is disposed not in parallel to the first corrector plate.

7. A micro-distance measuring device comprising:
a light projection part to project measurement light;
a lens to collect the projected measurement light;
a correction optical part to inversely correct astigmatism of the projected measurement light;
a translucent substrate on which the measurement light is incident at an oblique angle so that the astigmatism of the measurement light inversely corrected by the correction optical part is cancelled;
an object on which the measurement light passing though the translucent substrate is reflected and which is provided adjacent to the translucent substrate;
a light reception part to receive the reflected measurement light and detects a phase difference between polarized components of the received measurement light, which are different in the vibration direction; and
a calculation part to determine a distance between the substrate and the object on the basis of the detected phase difference.

8. The micro-distance measuring device according to claim 7, wherein the correction optical part includes a corrector plate in which the material and the thickness are substantially equal to those of the translucent substrate, and
in a polarization direction in which the measurement light is perpendicularly incident on the translucent substrate, the corrector plate is disposed so that the incident angle of the measurement light is substantially equal to the oblique angle, and in a polarization direction in which the measurement light is incident on the translucent substrate at an oblique angle, the corrector plate is disposed so as to be perpendicular to the measurement light.

9. The micro-distance measuring device according to claim 7, wherein the correction optical part is an even number of corrector plates in which the material is substantially equal to those of the translucent substrate,
the corrector plate has one or more first corrector plates and one or more second corrector plates, a total thickness of the first corrector plate and a total thickness of the second corrector plate being respectively equal substantially to half the thickness of the translucent substrate,
the first corrector plate is disposed in a polarization direction in which the measurement light is perpendicularly incident on the translucent substrate, so that the incident angle of the measurement light is substantially equal to the oblique angle, and the first corrector plate is disposed so as to be perpendicular to the measurement light in a polarization direction in which the measurement light is incident on the translucent substrate at an oblique angle, and
the second corrector plate is disposed in the polarization direction in which the measurement light is perpendicularly incident on the translucent substrate, so that the incident angle of the measurement light is substantially equal to the oblique angle, the second corrector plate is disposed so as to be perpendicular to the measurement light in the polarization direction in which the measurement light is incident on the translucent substrate at an oblique angle, and the second corrector plate is disposed not in parallel to the first corrector plate.
